(19) United States
(12) Patent Application Publication
(10) Pub. No.: US 2022/0202060 A1
(43) Pub. Date: Jun. 30, 2022

(54) Adjustable Height Cooling Die for High Moisture Extrusion Food Processing Including an Automatic Feedback Loop

(71) Applicant: The Livekindly Company Switzerland GmbH, Pfaffikon (CH)

(72) Inventor: Achim Knoch, Minden (DE)

(21) Appl. No.: 17/193,240

(22) Filed: Mar. 5, 2021

Related U.S. Application Data
(60) Provisional application No. 63/131,784, filed on Dec. 29, 2020.

(51) Int. Cl. A23P 30/20; B29C 48/25; B29C 48/82

(52) U.S. Cl. CPC A23P 30/20; B29C 48/82; B29C 48/2665

(57) ABSTRACT

A system for high moisture extrusion (HME) food processing using an adjustable height cooling die including an automatic dynamic HME feedback loop is described herein. In various embodiments, the system comprises: a high moisture extrusion (HME) system including adjustable input HME parameters to adjust resulting HME parameters thereby controlling quality of HME products, the high moisture extrusion (HME) system comprising: a feeding system; a barrel, the barrel comprising at least one screw; and the adjustable height cooling die for shaping of a food product comprising output product conditions. Further comprising: an electronic sensor system electronically connected to the feeding system, to the barrel, and to the adjustable height cooling die for the automatic dynamic HME feedback loop that automatically and dynamically controls the adjustable input HME parameters to adjust the resulting HME parameters and the output product conditions, thereby controlling a texture and a thickness of the food product.

### CROSS-REFERENCE TO RELATED APPLICATION

This patent application claims the domestic benefit of U.S. Provisional Patent Application Ser. No. 63/131,784, filed Dec. 29, 2020, titled “Adjustable Height Cooling Die for High Moisture Extrusion Food Processing Including an Automatic Feedback Loop,” which is hereby incorporated by reference herein in its entirety including all references cited therein.

### FIELD OF TECHNOLOGY

Embodiments of the present disclosure are directed to systems and methods for an adjustable height cooling die for high moisture extrusion (HME) food processing, and more particularly, not by limitation, an adjustable height cooling die for high moisture extrusion food processing including an automatic dynamic feedback loop.

### SUMMARY

According to some embodiments, the present technology is directed to a system for high moisture extrusion (HME) food processing using an adjustable height cooling die including an automatic dynamic HME feedback loop. In various embodiments the system comprises: a high moisture extrusion (HME) system including adjustable input HME parameters to adjust resulting HME parameters thereby controlling quality of HME products, the high moisture extrusion (HME) system comprising: a feeding system; a barrel, the barrel comprising at least one screw; and the adjustable height cooling die for shaping of a food product, the food product comprising output product conditions; and an electronic sensor system electronically connected to the feeding system, to the barrel including to a power unit of the at least one screw, and to the adjustable height cooling die for the automatic dynamic HME feedback loop, the automatic dynamic HME feedback loop automatically and dynamically controlling the adjustable input HME parameters to adjust the resulting HME parameters and the output product conditions, thereby controlling a texture and a thickness of the food product.

In various embodiments the adjustable input HME parameters include at least one of: a temperature of an extruder jacket, a temperature of a cooling agent in the extruder jacket, a speed of the at least one screw, a feed rate of input materials, a temperature of input materials, a feed rate of water input, a total throughput rate, a temperature of the adjustable height cooling die, a length of the adjustable height cooling die, a height of the adjustable height cooling die, and an indirect pressure control of the high moisture extrusion (HME) system.

In some embodiments the resulting HME parameters include at least one of: a pressure of the high moisture extrusion (HME) system and a temperature of the high moisture extrusion (HME) system.

In various embodiments the output product conditions of the food product include at least one of: a height of the food product, a temperature of the food product, and a rate of temperature change of the food product.

In some embodiments the adjustable input HME parameters include an indirect pressure control of the high moisture extrusion (HME) system and a height of the adjustable height cooling die; wherein the resulting HME parameters include a pressure of the high moisture extrusion (HME) system; wherein the output product conditions of the food product include a rate of temperature change of the food product and a height of the food product; wherein the electronic sensor system electronically connected to the adjustable height cooling die determines the rate of temperature change of the food product is less than a maximum threshold; and wherein the automatic dynamic HME feedback loop automatically increases the pressure of the high moisture extrusion (HME) system by decreasing the height of the adjustable height cooling die increasing the pressure of the high moisture extrusion (HME) system and, thereby decreasing the thickness of the food product by decreasing the height of the adjustable height cooling die and controlling the texture of the food product and the thickness of the food product.

In various embodiments the adjustable input HME parameters include indirect pressure control of the high moisture extrusion (HME) system and a height of the adjustable height cooling die; wherein the resulting HME parameters include a pressure of the high moisture extrusion (HME) system; wherein the output product conditions of the food product include a rate of temperature change of the food product and a height of the food product; wherein the electronic sensor system electronically connected to the adjustable height cooling die determines the rate of temperature change of the food product is greater than a maximum threshold; and wherein the automatic dynamic HME feedback loop automatically decreases the pressure of the high moisture extrusion (HME) system by increasing the height of the adjustable height cooling die, increasing the thickness of the food product by increasing the height of the adjustable height cooling die, thereby increasing the thickness of the food product and controlling the texture and the thickness of the food product.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 illustrates a system for high moisture extrusion (HME) food processing using an adjustable height cooling die, according to various embodiments of the present technology.

FIG. 2 illustrates a system for high moisture extrusion (HME) food processing using an adjustable height cooling die including an automatic dynamic HME feedback loop, according to various embodiments of the present technology.

FIG. 3 illustrates an adjustable height cooling die, according to various embodiments of the present technology including various parameters, according to various embodiments of the present technology.

FIG. 4 illustrates a system for a moveable lid for changing a height of the adjustable height cooling die, according to various embodiments of the present technology.

FIG. 5 shows a table of various parameters of a system for high moisture extrusion (HME) food processing using an adjustable height cooling die including an automatic dynamic HME feedback loop, according to various embodiments of the present technology.

FIG. 6 is a diagrammatic representation of an example machine in the form of a computer system, according to various embodiments of the present technology.

### DESCRIPTION OF EXEMPLARY EMBODIMENTS

High moisture extrusion (HME) has been developed to produce products of uniform shape and density, and industrial application of the HME dates many years. HME a widely applied processing technology across various industries including the food industry for producing protein products. HME is carried out by using an extruder. For example, an extruder may include a barrel containing at least one rotating screw that transports pumped-in materials down the barrel and through an orifice (e.g., a die) producing products of uniform shape and density. The HME process may be completed under controlled conditions, such as temperature, feed rate, and pressure to control the product.

In various embodiments the present technology solves the problem of the extrusion process being unstable because of changing pressure and temperature conditions. The present technology solves this stability problem by stabilizing pressure and temperature during the extrusion process. For example, since pressure cannot be set directly, but pressure results from a large number of environmental parameters, a weighty environmental parameter is suitable for solving this problem. Furthermore, since the geometry of the nozzle has a great influence on the pressure conditions in the extruder, this parameter is suitable for achieving stabilization.

In various embodiments HME processing technologies are used to produce food products of uniform shape and density made from the input material(s). The design of the cooling equipment for HME when making food products is important because cooling of the material(s) has a significant impact in the texture of the food products made from the material(s). Furthermore, the cooling of the material(s) by the adjustable height cooling die design determines a maximum throughput of the HME process and may limit the throughput.

In various embodiments cooling dies with increased the height may lead to problems with the HME process and makes the HME process more sensitive and instable. For example, during the HME process parameters including pressure and torque begin to fluctuate and even throughput may be unstable. For example, the extruder may start to pump, and the throughput of the HME process may be limited by increasing the height of the die (e.g., cooling die). In some instances, as a height of the die increases, the risk of having a core flow in the die increases as well.

In various embodiment of the present technology, a solution is a die (i.e., cooling die) with an adjustable height including an automatic dynamic HME feedback loop. In some embodiments, the adjustable height of the die (i.e., cooling die) is regulated by a control technique of the HME process. Thus, control of the variables of the HME process including temperature, feed rate, and indirect pressure control of the high moisture extrusion (HME) system, control the food product. For instance, changing an amount of water in the water feed of the high moisture extrusion (HME) system indirectly controls pressure of the high moisture extrusion (HME) system and is an example of the indirect pressure control. In other words, a change in pressure of the high moisture extrusion (HME) system results from changing another input parameter such as an amount of moisture. For example, if an increasing pressure of the high moisture extrusion (HME) system is determined, then the height of the cooling die may be increased using the automatic dynamic HME feedback loop to decrease the pressure of the high moisture extrusion (HME) system. Conversely, if a decreasing pressure of the high moisture extrusion (HME) system is determined, then the height of the cooling die may be decreased using the automatic dynamic HME feedback loop to increase the pressure of the high moisture extrusion (HME) system.

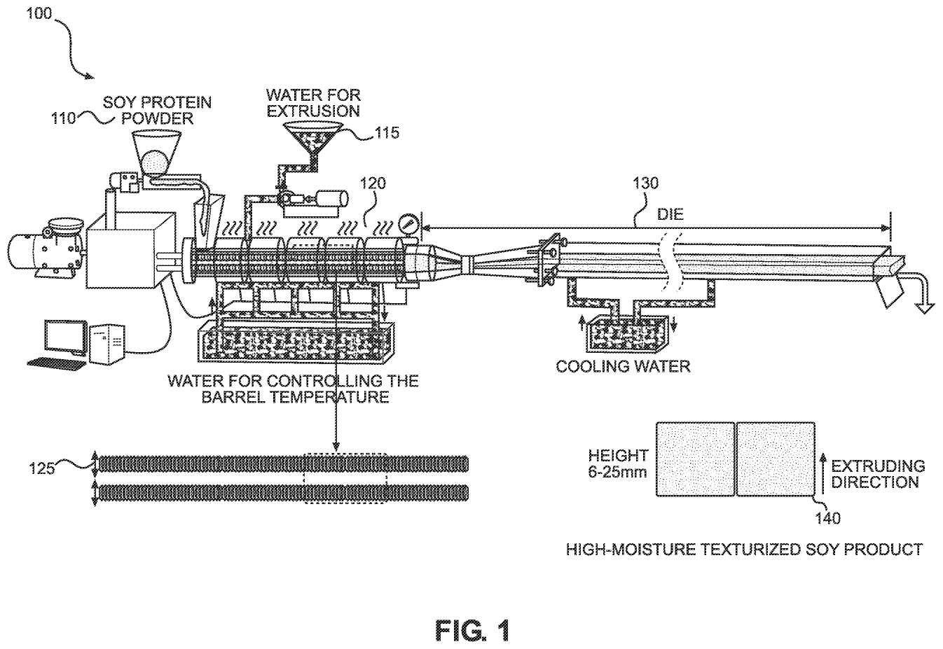

FIG. 1 illustrates a system for high moisture extrusion (HME) food processing 100 using an adjustable height cooling die 130, according to various embodiments of the present technology. In various embodiments an extruder used for HME comprises four parts including the following. First, an opening though which material(s) enter the barrel from a hopper in a controlled manner using an external gravimetric feeder 110 as shown as in FIG. 1. The input material(s) may be soy protein powder, soy protein concentrate, any plant-based protein, and the like. Water is an important input material for high moisture extrusion (HME) food processing and is shown being added using an external gravimetric water feeder 115 as shown as in FIG. 1. Furthermore, a flow meter to control a flow of water is important for high moisture extrusion (HME) food processing. The material(s) including water may be extruded or continuously supplied to the extruder. Second, a conveying (i.e., process) section comprising a barrel 120 and at least one screw 125 that transports and mixes the material(s) as shown as in FIG. 1. For example, the at least one screw 125 may mix input materials such as soy protein concentrate and water. Furthermore, around the extruder, a heating/cooling medium flows through an extruder jacket surrounding the barrel 120 shown as water for controlling the barrel temperature as shown in FIG. 1 that may be used with an extruder jacket to control a temperature of the barrel 120. For example, the adjustable input HME parameters may include a temperature of a cooling agent in the extruder jacket (i.e., control of the heating/cooling medium flowing through the extruder jacket surrounding the barrel 120). Third, an adjustable height cooling die 130 (e.g., an orifice) for shaping and cooling-down the input material(s) as the material(s) leave the extruder as shown in FIG. 1. Fourth, downstream auxiliary equipment for cooling, cutting, and/or collecting a finished product made from the material(s). For example, cooling water for controlling the temperature of the adjustable height cooling die as shown in FIG. 1. Significantly, the adjustable height cooling die 130 may be used for shaping of a food product shown as 140, the food product 140 comprising output product conditions. For example, the output product conditions of the food product 140 may include a height of the food product 140, a temperature of the food product 140, and a rate of temperature change of the food product 140.

In various embodiments a height of the adjustable height cooling die 130 is an important factor of the cooling process and determines the shape including the height of the products (e.g., food product 140) made from the material(s) and the internal texture of the products (e.g., food product 140). In some instances, the adjustable height cooling die 130 is a height of between 6 to 12 mm, limiting the height of the food product 140 made from the input material(s). In various embodiments of the present technology, the adjustable height cooling die 130 that has a height of 25 mm or greater is used to produce a food product 140 with an increased height allowing for a food product 140 of increased thickness. For example, an adjustable height cooling die 130 with a height of 25 mm allows for using the HME process to produce food products with increased thickness up to 25 mm such as a steak food product or a chicken breast food product made from soy protein powder and water. For example, food products with a height between 6-25 mm is shown in FIG. 1 as a high-moisture textured soy product.

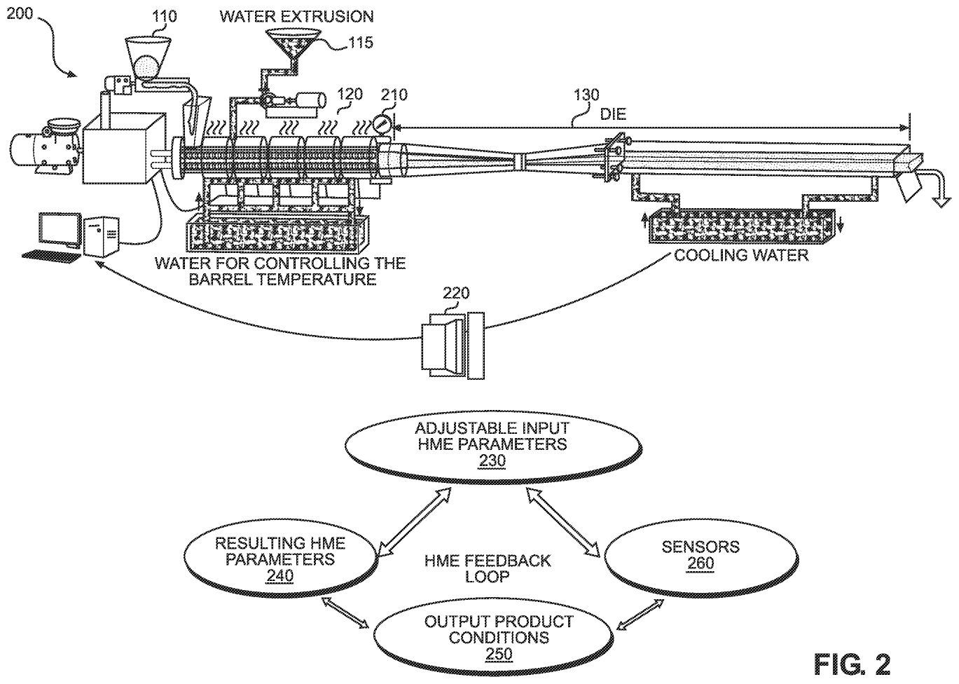

FIG. 2 illustrates a system for high moisture extrusion (HME) food processing using an adjustable height cooling die 130 including an automatic dynamic HME feedback loop 220, according to various embodiments of the present technology. FIG. 2 shows an electronic sensor system 210 electronically connected to the feeding system (e.g., the external gravimetric feeder 110 and external gravimetric water feeder 115), to the barrel 120 including to a power unit of the at least one screw 125, and to the adjustable height cooling die 130 for the automatic dynamic HME feedback loop 220, the automatic dynamic HME feedback loop 220 may automatically and dynamically control the adjustable input HME parameters 230 to adjust the resulting HME parameters 240 and the output product conditions 250, thereby controlling a texture and a thickness of the food product (e.g. food product 140 shown in FIG. 1).

In various embodiments the automatic dynamic HME feedback loop 220 may be controlled by using a computing system such as the exemplary computing system described in FIG. 6. The automatic dynamic HME feedback loop 220 may be performed by processing logic that may comprise hardware (e.g., dedicated logic, programmable logic, and microcode), software (such as software run on a general-purpose computer system or a dedicated machine), or a combination thereof.

FIG. 2 illustrates an HME feedback loop (the automatic dynamic HME feedback loop 220) including adjustable input HME parameters 230, resulting HME parameters 240, and output product conditions 250 of the food product 140, and sensors 260 (the electronic sensor system 210 for the automatic dynamic HME feedback loop 220 connected with the HME process) according to various embodiments of the present technology. For example, the adjustable input HME parameters 230 may include a temperature of an extruder jacket, a temperature of a cooling agent (e.g., water or any cooling/heating medium) in the extruder jacket, a speed of the at least one screw 124, a feed rate of input materials (e.g., using the external gravimetric feeder 110), a temperature of input materials, a feed rate of water input (e.g., using the external gravimetric water feeder 115), a total throughput rate, a temperature of the adjustable height cooling die 130, a length of the adjustable height cooling die 130, a height of the adjustable height cooling die 130, and an indirect pressure control of the high moisture extrusion (HME) system. For instance, a ratio of plant-based protein to water may be controlled by controlling the feed rate of input materials (e.g., using the external gravimetric feeder 110) and the feed rate of water input (e.g., using the external gravimetric water feeder 115 that may include a water flow meter). For example, the resulting HME parameters 240 may include a pressure of the high moisture extrusion (HME) system and a temperature of the high moisture extrusion (HME) system. For example, the output product conditions 250 of the food product 140 may include a height of the food product 140, a temperature of the food product 140, and a rate of temperature change of the food product 140.

In various embodiments the high moisture extrusion (HME) system includes the electronic sensor system 210 for the automatic dynamic HME feedback loop 220 connected with the HME process. For example, if the electronic sensor system 210 determines that the food product 140 is cooling too quickly, the height of the adjustable height cooling die 130 may be automatically increased to slow of the cooling of the food product 140. Conversely, if the electronic sensor system 210 determines that the food product 140 is cooling too slowly, the height of the adjustable height cooling die 130 may be automatically decreased to speed-up the cooling of the food product 140. In this way, the electronic sensor system 210 of the adjustable height cooling die 130 allows for an automatic dynamic HME feedback loop 220 connected with the HME process to make real-time adjustments of the cooling process and to make micro adjustments to products. There may be a lag time between changing the adjustable height cooling die 130 and the resulting change of the process parameters in various embodiments.

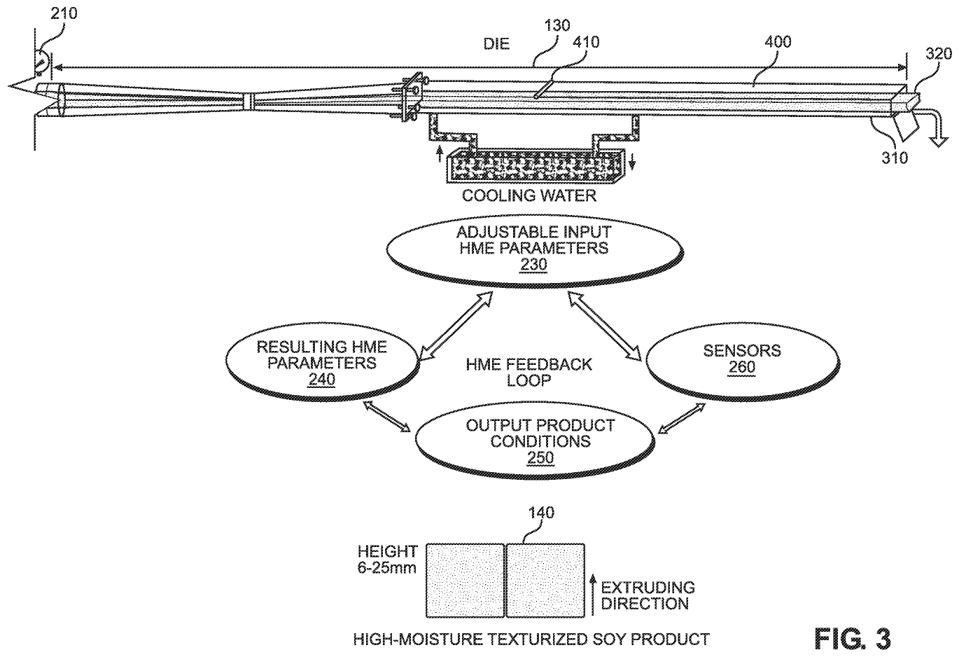

FIG. 3 illustrates an adjustable height cooling die 130, according to various embodiments of the present technology including various parameters, according to various embodiments of the present technology. FIG. 3 further illustrates the HME feedback loop (the automatic dynamic HME feedback loop 220) including adjustable input HME parameters 230, resulting HME parameters 240, and output product conditions 250 of the food product 140, and sensors 260 (the electronic sensor system 210 for the automatic dynamic HME feedback loop 220 connected with the HME process) according to various embodiments of the present technology.

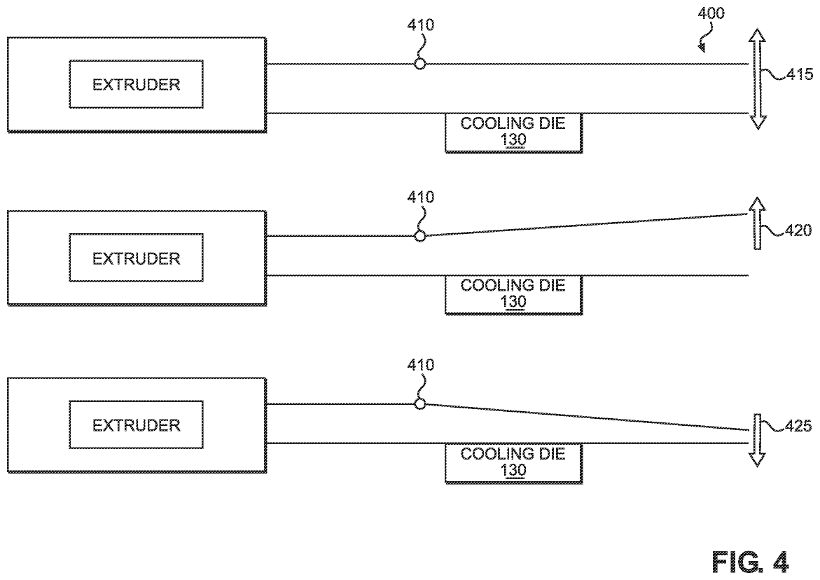

FIG. 3 further illustrates the adjustable height cooling die 130 for shaping of the food product 140 comprising a moveable lid 400 for changing a height of the adjustable height cooling die 130 that may be moved both upwards and downwards (as shown in FIG. 4) according to various embodiments. The moveable lid 400 may be moved up or moved down to adjust the height of the adjustable height cooling die 130 (as shown in FIG. 4). For example, the moveable lid 400 may be adjustable using an adjustment point 410.

In various embodiments, the adjustable height cooling die 130 is done in an area of the die, where the protein melt is still flowable and not yet fully texturized so that the shape and density of the food product 140 may still be controlled.

In some embodiments, the adjustable height cooling die 130 uses wherein the adjustable height cooling die comprises a round gap in the adjustable height cooling die, the round gap being adjustable in a horizontal direction 310 for shaping of the food product 140. For instance, the adjustable height cooling die 130 may be adjustable in the horizontal direction 310. For example, the adjustable height of the cooling die may be done at a beginning of a cooling channel rather than at an outlet of the extruder.

In various embodiments, the adjustable height cooling die 130 uses a flat die that is adjusted in vertical direction 320. For instance, the adjustable height cooling die 130 may be adjustable in the vertical direction 320. In some instances, the adjustable height cooling die 130 may be a flat die includes a lid (e.g., moveable lid 400 as shown in FIG. 4).

In various embodiments, the adjustable height of the adjustable height cooling die 130 allows for production of different a variety of different food products with different thicknesses using a single adjustable height die (i.e., cooling die). In various embodiments the adjustable height cooling die 130 may be used to produce a variety of products including a meat analog strip (e.g., a meat analog strip with a height of 8 mm), a wing (e.g., a wing with a height of 10 mm), and a chicken breast (e.g., a chicken breast with a height of 22 mm). For example, a variety of different products with different heights including the meat analog strip with a height of 8 mm, the wing with a height of 10 mm, and the chicken breast with a height of 22 mm may all be made with the same adjustable height cooling die 130 allowing for efficiency in production of different food products because a single die (i.e., the adjustable height cooling die 130) that includes an adjustable height may be used rather than having to use a different cooling die for each food product with a different height. product or a chicken breast food product made from soy protein powder and water. For example, food products with a height between 6-25 mm is shown in FIG. 1 as a high-moisture textured soy product. For example, a variety of different products with different heights including the meat analog strip with a height of 8 mm, the wing with a height of 10 mm, and the chicken breast with a height of 22 mm may all be made with the same adjustable height cooling die 130.

According to some embodiments, the adjustable input HME parameters 230 include an indirect pressure control of the high moisture extrusion (HME) system and a height of the adjustable height cooling die 130; the resulting HME parameters 240 include a pressure of the high moisture extrusion (HME) system; and the output product conditions 250 of the food product 140 include a rate of temperature change of the food product 140 and a height of the food product 140. For instance, wherein the electronic sensor system 210 electronically connected to the adjustable height cooling die 130 determines the rate of temperature change of the food product 140 is less than a maximum threshold; and wherein the automatic dynamic HME feedback loop 220 automatically increases the pressure of the high moisture extrusion (HME) system by decreasing the height of the adjustable height cooling die 130 increasing the pressure of the high moisture extrusion (HME) system and, thereby decreasing the thickness of the food product 140 by decreasing the height of the adjustable height cooling die 130 and controlling the texture of the food product 140 and the thickness of the food product 140.

According to various embodiments, the adjustable input HME parameters 230 include indirect pressure control of the high moisture extrusion (HME) system and a height of the adjustable height cooling die 130; wherein the resulting HME parameters 240 include a pressure of the high moisture extrusion (HME) system; wherein the output product conditions 250 of the food product 140 include a rate of temperature change of the food product 140 and a height of the food product 140; wherein the electronic sensor system 210 electronically connected to the adjustable height cooling die determines the rate of temperature change of the food product 140 is greater than a maximum threshold; and wherein the automatic dynamic HME feedback loop 220 automatically decreases the pressure of the high moisture extrusion (HME) system by increasing the height of the adjustable height cooling die, increasing the thickness of the food product 140 by increasing the height of the adjustable height cooling die, thereby increasing the thickness of the food product 140 and controlling the texture and the thickness of the food product 140.

FIG. 4 illustrates a system for a moveable lid 400 for changing a height of the adjustable height cooling die 130, according to various embodiments of the present technology. For example, the adjustable height cooling die 130 for shaping of the food product 140 comprises a moveable lid 400 for changing a height of the adjustable height cooling die 130 that may be moved both upwards and downwards as shown in FIG. 4. The moveable lid 400 may be moved up or moved down to adjust the height of the adjustable height cooling die 130 as shown in FIG. 4. FIG. 4 shows the extruder as a block diagram with the moveable lid 400 adjustable using an adjustment point 410. In some embodiments, the moveable lid 400 may be adjusted bidirectionally 415. In various embodiments, the moveable lid 400 may be adjusted upwards 420. In some embodiments, the moveable lid 400 may be adjusted downwards 425. In various embodiments a portion of the moveable lid is movable. In some embodiments the moveable lid is completely movable. The moveable lid may be cooled by a cooling agent like the other parts of the cooling die.

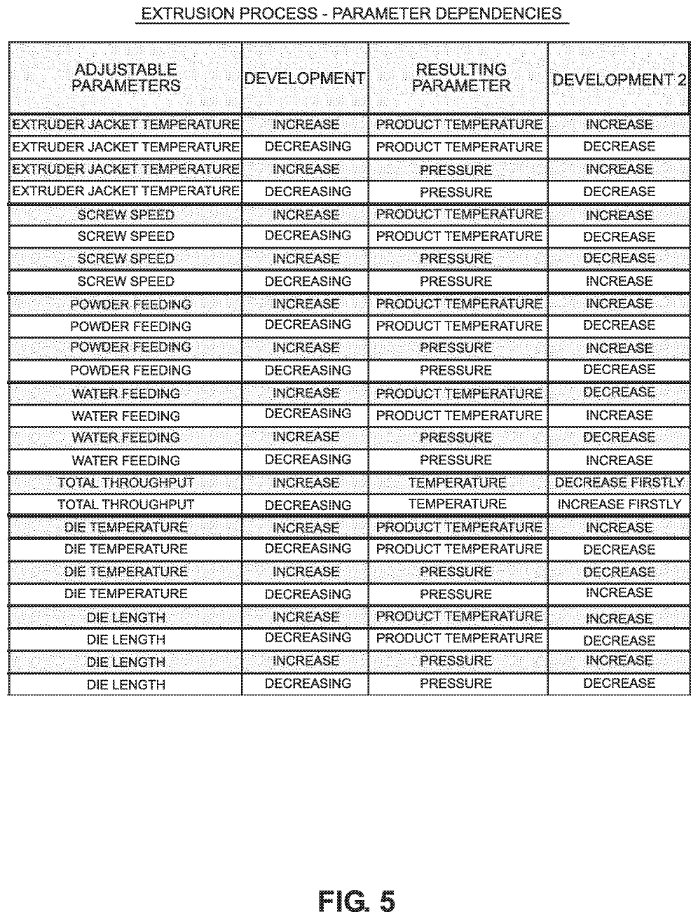

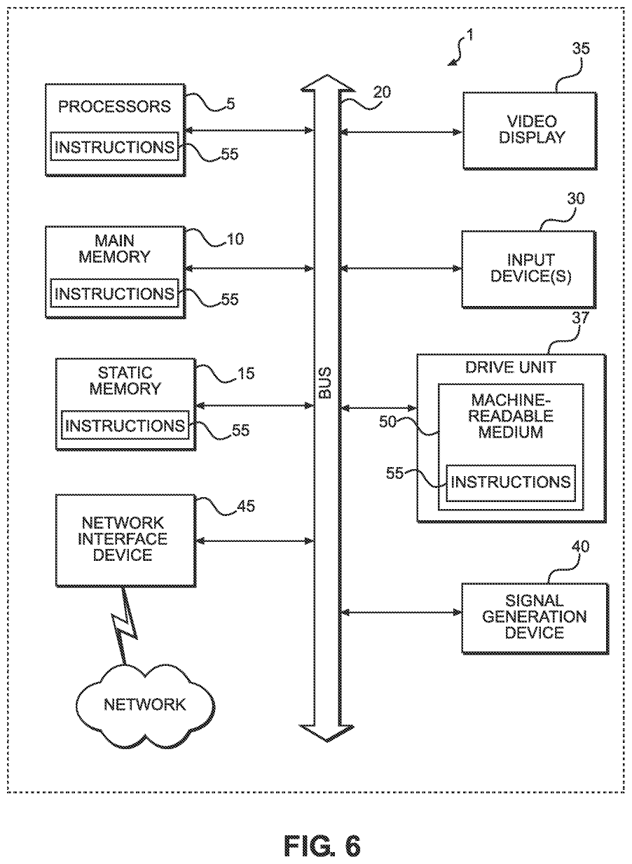

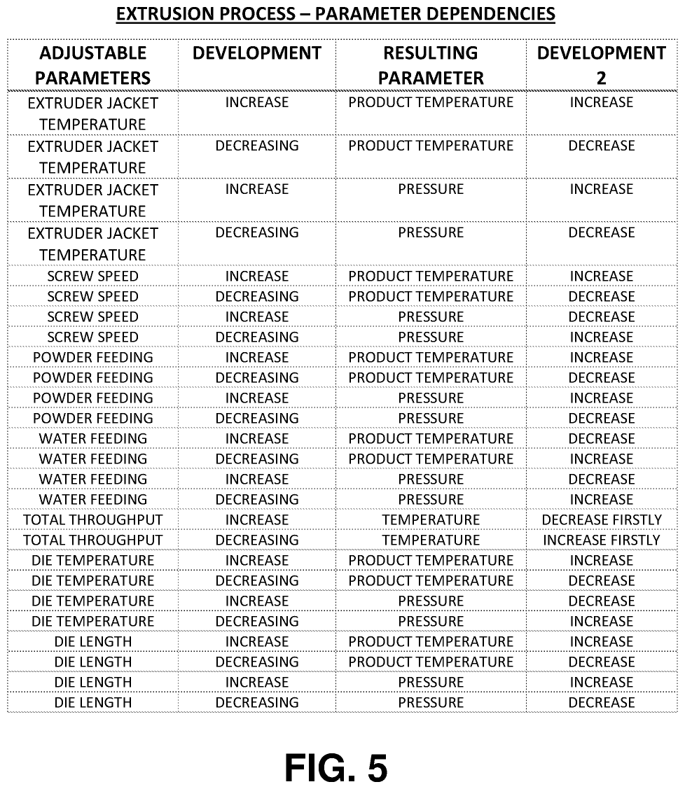

FIG. 5 shows a table of various parameters of a system for high moisture extrusion (HME) food processing using the adjustable height cooling die 130 including the automatic dynamic HME feedback loop 220, according to various embodiments of the present technology. The table of FIG. 5 shows parameter dependencies for the extrusion process. For instance, the table of FIG. 5 shows various adjustable parameters (i.e., adjustable input HME parameters 230) and a corresponding development (e.g., increase or decreasing). The table of FIG. 5 further shows resulting parameters (i.e., resulting HME parameters 240) and a corresponding development two (e.g., increase or decrease). The parameter dependencies shown in FIG. 5 are according to various embodiments of the present technology and here may be special process conditions or raw materials that lead to different parameter dependencies in some embodiments.

According to various embodiments, the automatic dynamic HME feedback loop 220 automatically and dynamically, based on the electronic sensor system 210 dynamically controls parameter dependencies for the extrusion process including the adjustable parameters (i.e., adjustable input HME parameters 230), which results in the corresponding development (e.g., increase or decreasing) and further results in the resulting parameters (i.e., resulting HME parameters 240) and the corresponding development two (e.g., increase or decrease), thereby dynamically controlling the texture of the food product 140 and the thickness of the food product 140. For example, the adjustable parameters (i.e., adjustable input HME parameters 230) may include the following: extruder jacket temperature, temperature of a cooling agent in the extruder jacket, screw speed (i.e., a speed of the at least one screw 125), powder feeding (i.e., a feed rate of input materials (e.g., using the external gravimetric feeder 110)), water feeding (i.e., a feed rate of water input (e.g., using the external gravimetric water feeder 115)), total throughput (i.e., total amount of food product 140 produced per measure of time), die temperature (i.e., temperature of the adjustable height cooling die 130), and die length (i.e., length of the adjustable height cooling die 130) Additionally, for example, resulting parameters (i.e., resulting HME parameters 240) may include the following: product temperature (i.e., temperature of the food product 140), and pressure (i.e., pressure of the high moisture extrusion (HME) system). In this way, the automatic dynamic HME feedback loop 220 connected with the HME process including the adjustable height cooling die 130 and the electronic sensor system 210 allows for real- time adjustments of the cooling process to make micro adjustments to food products (e.g., food product 140), thereby dynamically controlling the texture of the food product 140 and the thickness of the food product 140.

In some embodiments, wherein the adjustable input HME parameters 230 include a temperature of an extruder jacket; wherein the resulting HME parameters 240 include a pressure of the high moisture extrusion (HME) system; wherein the output product conditions 250 of the food product 140 include a temperature of the food product 140; wherein the electronic sensor system 210 electronically connected to the adjustable height cooling die 130 dynamically determines the temperature of the food product 140; and wherein the automatic dynamic HME feedback loop 220 automatically and dynamically, based on the electronic sensor system 210 dynamically determining the temperature of the food product 140 compared to a target temperature, increases the temperature of the food product 140 by increasing the temperature profile of the extruder jacket if the temperature of the food product 140 is below the target temperature or decreases the temperature of the food product 140 by decreasing the temperature profile of the extruder jacket if the temperature of the food product 140 is above the target temperature, thereby dynamically controlling the texture of the food product 140 and the thickness of the food product 140. For example, a temperature of a cooling agent in the extruder jacket (e.g., heating/cooling medium may be used to control the temperature profile of the extruder jacket. Furthermore, there may be multiple barrels with different temperatures controlling the temperature profile of the extruder jacket.

In various embodiments, wherein the adjustable input HME parameters 230 include a temperature of an extruder jacket; wherein the resulting HME parameters 240 include a pressure of the high moisture extrusion (HME) system; wherein the output product conditions 250 of the food product 140 include a temperature of the food product 140; wherein the electronic sensor system 210 electronically connected to the adjustable height cooling die 130 dynamically determines the pressure of the high moisture extrusion (HME) system; and wherein the automatic dynamic HME feedback loop 220 automatically and dynamically, based on the electronic sensor system 210 dynamically determining the pressure of the high moisture extrusion (HME) system compared to a target pressure, increases the pressure of the high moisture extrusion (HME) system by increasing the temperature profile of the extruder jacket if the pressure of the high moisture extrusion (HME) system is below the target pressure or decreases the pressure of the high moisture extrusion (HME) system by decreasing the temperature profile of the extruder jacket if the pressure of the high moisture extrusion (HME) system is above the target pressure, thereby dynamically controlling the texture of the food product 140 and the thickness of the food product 140. For example, a temperature of a cooling agent (e.g., heating/cooling medium) in the extruder jacket may be used to control the temperature profile of the extruder jacket. Furthermore, there may be multiple barrels and each barrel may have a defined temperature.

In some embodiments, wherein the adjustable input HME parameters 230 include a speed of the at least one screw 125; wherein the resulting HME parameters 240 include a pressure of the high moisture extrusion (HME) system; wherein the output product conditions 250 of the food product 140 include a temperature of the food product 140; wherein the electronic sensor system 210 electronically connected to the adjustable height cooling die 130 dynamically determines the temperature of the food product 140; and wherein the automatic dynamic HME feedback loop 220 automatically and dynamically, based on the electronic sensor system 210 dynamically determining the temperature of the food product 140 compared to a target temperature, increases the temperature of the food product 140 by increasing the speed of the at least one screw 125 if the temperature of the food product 140 is below the target temperature or decreases the temperature of the food product 140 by decreasing the speed of the at least one screw 125 if the temperature of the food product 140 is above the target temperature, thereby dynamically controlling the texture of the food product 140 and the thickness of the food product 140.

In various embodiments, wherein the adjustable input HME parameters 230 include a speed of the at least one screw 125; wherein the resulting HME parameters 240 include a pressure of the high moisture extrusion (HME) system; wherein the output product conditions 250 of the food product 140 include a temperature of the food product 140; wherein the electronic sensor system 210 electronically connected to the adjustable height cooling die 130 dynamically determines the pressure of the high moisture extrusion (HME) system; and wherein the automatic dynamic HME feedback loop 220 automatically and dynamically, based on the electronic sensor system 210 dynamically determining the pressure of the high moisture extrusion (HME) system compared to a target pressure, increases the pressure of the high moisture extrusion (HME) system by decreasing the speed of the at least one screw 125 if the pressure of the high moisture extrusion (HME) system is below the target pressure or decreases the pressure of the high moisture extrusion (HME) system by increasing the speed of the at least one screw 125 if the pressure of the high moisture extrusion (HME) system is above the target pressure, thereby dynamically controlling the texture of the food product 140 and the thickness of the food product 140.

In some embodiments, wherein the adjustable input HME parameters 230 include a feed rate of input materials; wherein the resulting HME parameters 240 include a pressure of the high moisture extrusion (HME) system; wherein the output product conditions 250 of the food product 140 include a temperature of the food product 140; wherein the electronic sensor system 210 electronically connected to the adjustable height cooling die 130 dynamically determines the temperature of the food product 140; and wherein the automatic dynamic HME feedback loop 220 automatically and dynamically, based on the electronic sensor system 210 dynamically determining the temperature of the food product 140 compared to a target temperature, increases the temperature of the food product 140 by increasing the feed rate of input materials if the temperature of the food product 140 is below the target temperature or decreases the temperature of the food product by decreasing the feed rate of input materials if the temperature of the food product 140 is above the target temperature, thereby dynamically controlling the texture of the food product 140 and the thickness of the food product 140.

In some embodiments, wherein the adjustable input HME parameters 230 include a feed rate of input materials; wherein the resulting HME parameters 240 include a pressure of the high moisture extrusion (HME) system; wherein the output product conditions 250 of the food product 140 include a temperature of the food product 140; wherein the electronic sensor system 210 electronically connected to the adjustable height cooling die 130 dynamically determines the pressure of the high moisture extrusion (HME) system; and wherein the automatic dynamic HME feedback loop 220 automatically and dynamically, based on the electronic sensor system 210 dynamically determining the pressure of the high moisture extrusion (HME) system compared to a target pressure, increases the pressure of the high moisture extrusion (HME) system by increasing the feed rate of the input materials if the pressure of the high moisture extrusion (HME) system is below the target pressure or decreases the pressure of the high moisture extrusion (HME) system by decreasing the feed rate of the input materials if the pressure of the high moisture extrusion (HME) system is above the target pressure, thereby dynamically controlling the texture of the food product 140 and the thickness of the food product 140.

In some embodiments, wherein the adjustable input HME parameters 230 include a feed rate of water input; wherein the resulting HME parameters 240 include a pressure of the high moisture extrusion (HME) system; wherein the output product conditions 250 of the food product 140 include a temperature of the food product 140; wherein the electronic sensor system 210 electronically connected to the adjustable height cooling die 130 dynamically determines the temperature of the food product; and wherein the automatic dynamic HME feedback loop 220 automatically and dynamically, based on the electronic sensor system 210 dynamically determining the temperature of the food product 140 compared to a target temperature, increases the temperature of the food product 140 by decreasing the feed rate of water input if the temperature of the food product 140 is below the target temperature or decreases the temperature of the food product 140 by increasing the feed rate of water input if the temperature of the food product 140 is above the target temperature, thereby dynamically controlling the texture of the food product 140 and the thickness of the food product 140.

In some embodiments, wherein the adjustable input HME parameters 230 include a feed rate of water input; wherein the resulting HME parameters 240 include a pressure of the high moisture extrusion (HME) system; wherein the output product conditions 250 of the food product 140 include a temperature of the food product 140; wherein the electronic sensor system 210 electronically connected to the adjustable height cooling die 130 dynamically determines the pressure of the high moisture extrusion (HME) system; and wherein the automatic dynamic HME feedback loop 220 automatically and dynamically, based on the electronic sensor system 210 dynamically determining the pressure of the high moisture extrusion (HME) system compared to a target pressure, increases the pressure of the high moisture extrusion (HME) system by decreasing the feed rate of water input if the pressure of the high moisture extrusion (HME) system is below the target pressure or decreases the pressure of the high moisture extrusion (HME) system by increasing the feed rate of water input if the pressure of the high moisture extrusion (HME) system is above the target pressure, thereby dynamically controlling the texture of the food product 140 and the thickness of the food product 140.

In some embodiments, wherein the adjustable input HME parameters 230 include a total throughput rate; wherein the resulting HME parameters 240 include a temperature of the high moisture extrusion (HME) system; wherein the electronic sensor system 210 electronically connected to the adjustable height cooling die 130 dynamically determines the temperature of the high moisture extrusion (HME) system; and wherein the automatic dynamic HME feedback loop 220 automatically and dynamically, based on the electronic sensor system 210 dynamically determining the temperature of the high moisture extrusion (HME) system compared to a target temperature, increases the temperature of the high moisture extrusion (HME) system by increasing the total throughput rate if the temperature of the high moisture extrusion (HME) system is below the target temperature or decreases the temperature of the high moisture extrusion (HME) system by decreasing the total throughput rate if the temperature of the high moisture extrusion (HME) system is above the target temperature, thereby dynamically controlling the texture of the food product 140 and the thickness of the food product 140.

In some embodiments, wherein the adjustable input HME parameters 230 include a temperature of the adjustable height cooling die 130; wherein the resulting HME parameters 240 include a pressure of the high moisture extrusion (HME) system; wherein the output product conditions 250 of the food product 140 include a temperature of the food product 140; wherein the electronic sensor system 210 electronically connected to the adjustable height cooling die 130 dynamically determines the temperature of the food product 140; and wherein the automatic dynamic HME feedback loop 220 automatically and dynamically, based on the electronic sensor system 210 dynamically determining the temperature of the food product 140 compared to a target temperature, increases the temperature of the food product 140 by increasing the temperature of the adjustable height cooling die 130 if the temperature of the food product 140 is below the target temperature or decreases the temperature of the food product 140 by decreasing the temperature of the adjustable height cooling die 130 if the temperature of the food product 140 is above the target temperature, thereby dynamically controlling the texture of the food product 140 and the thickness of the food product 140.

In some embodiments, wherein the adjustable input HME parameters 230 include a temperature of the adjustable height cooling die 130; wherein the resulting HME parameters 240 include a pressure of the high moisture extrusion (HME) system; wherein the output product conditions 250 of the food product 140 include a temperature of the food product 140; wherein the electronic sensor system 210 electronically connected to the adjustable height cooling die 130 dynamically determines the pressure of the high moisture extrusion (HME) system; and wherein the automatic dynamic HME feedback loop 220 automatically and dynamically, based on the electronic sensor system 210 dynamically determining the pressure of the high moisture extrusion (HME) system compared to a target pressure, increases the pressure of the high moisture extrusion (HME) system by decreasing the temperature of the adjustable height cooling die 130 if the pressure of the high moisture extrusion (HME) system is below the target pressure or decreases the pressure of the high moisture extrusion (HME) system by increasing the temperature of the adjustable height cooling die 130 if the pressure of the high moisture extrusion (HME) system is above the target pressure, thereby dynamically controlling the texture of the food product 140 and the thickness of the food product 140.

In some embodiments, wherein the adjustable input HME parameters 230 include a length of the adjustable height cooling die 130; wherein the resulting HME parameters 240 include a pressure of the high moisture extrusion (HME) system; wherein the output product conditions 250 of the food product 140 include a temperature of the food product 140; wherein the electronic sensor system 210 electronically connected to the adjustable height cooling die 130 dynamically determines the temperature of the food product 140; and wherein the automatic dynamic HME feedback loop 220 automatically and dynamically, based on the electronic sensor system 210 dynamically determining the temperature of the food product 140 compared to a target temperature, increases the temperature of the food product 140 by increasing the length of the adjustable height cooling die 130 if the temperature of the food product 140 is below the target temperature or decreases the temperature of the food product 140 by decreasing the length of the adjustable height cooling die 130 if the temperature of the food product 140 is above the target temperature, thereby dynamically controlling the texture of the food product 140 and the thickness of the food product 140.

In some embodiments, wherein the adjustable input HME parameters 230 include a length of the adjustable height cooling die 130; wherein the resulting HME parameters 240 include a pressure of the high; wherein the output product conditions 250 of the food product 140 include a temperature of the food product 140; wherein the electronic sensor system 210 electronically connected to the adjustable height cooling die 130 dynamically determines the pressure of the high moisture extrusion (HME) system; and wherein the automatic dynamic HME feedback loop 220 automatically and dynamically, based on the electronic sensor system 210 dynamically determining the pressure of the high moisture extrusion (HME) system compared to a target pressure, increases the pressure of the high moisture extrusion (HME) system by increasing the length of the adjustable height cooling die 130 if the pressure of the high moisture extrusion (HME) system is below the target pressure or decreases the pressure of the high moisture extrusion (HME) system by decreasing the length of the adjustable height cooling die 130 if the pressure of the high moisture extrusion (HME) system is above the target pressure, thereby dynamically controlling the texture of the food product 140 and the thickness of the food product 140.

FIG. 6 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as a Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The disk drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While this technology is susceptible of embodiments in many different forms, there is shown in the drawings and has been described in detail several specific embodiments with the understanding that the present disclosure is to be considered as an exemplification of the principles of the technology and is not intended to limit the technology to the embodiments illustrated.

Although the terms first, second, etc. may be used herein to describe various elements, components, regions, layers and/or sections, these elements, components, regions, layers and/or sections should not necessarily be limited by such terms. These terms are only used to distinguish one element, component, region, layer or section from another element, component, region, layer or section. Thus, a first element, component, region, layer or section discussed below could be termed a second element, component, region, layer or section without departing from the teachings of the present disclosure.

The terminology used herein is for the purpose of describing particular embodiments only and is not intended to be necessarily limiting of the disclosure. As used herein, the singular forms “a,” “an” and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence or addition of one or more other features, integers, steps, operations, elements, components, and/or groups thereof.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Unless otherwise defined, all terms (including technical and scientific terms) used herein have the same meaning as commonly understood by one of ordinary skill in the art to which this disclosure belongs. The terms, such as those defined in commonly used dictionaries, should be interpreted as having a meaning that is consistent with their meaning in the context of the relevant art and should not be interpreted in an idealized and/or overly formal sense unless expressly so defined herein.

Furthermore, relative terms such as “below,” “lower,” “above,” and “upper” may be used herein to describe one element's relationship to another element as illustrated in the accompanying drawings. Such relative terms are intended to encompass different orientations of illustrated technologies in addition to the orientation depicted in the accompanying drawings. For example, if a device in the accompanying drawings is turned over, then the elements described as being on the “lower” side of other elements would then be oriented on “upper” sides of the other elements. Similarly, if the device in one of the figures is turned over, elements described as “below” or “beneath” other elements would then be oriented “above” the other elements. Therefore, the example terms “below” and “lower” can, therefore, encompass both an orientation of above and below.

The description of the present disclosure has been presented for purposes of illustration and description but is not intended to be exhaustive or limited to the present disclosure in the form disclosed. Many modifications and variations will be apparent to those of ordinary skill in the art without departing from the scope and spirit of the present disclosure. Exemplary embodiments were chosen and described in order to best explain the principles of the present disclosure and its practical application, and to enable others of ordinary skill in the art to understand the present disclosure for various embodiments with various modifications as are suited to the particular use contemplated.

While various embodiments have been described above, it should be understood that they have been presented by way of example only, and not limitation. The descriptions are not intended to limit the scope of the technology to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the technology as defined by the appended claims and otherwise appreciated by one of ordinary skill in the art. The scope of the technology should, therefore, be determined not with reference to the above description, but instead should be determined with reference to the appended claims along with their full scope of equivalents.

What is claimed is:

1. A system for high moisture extrusion (HME) food processing using an adjustable height cooling die including an automatic dynamic HME feedback loop, the system comprising:
a high moisture extrusion (HME) system including adjustable input HME parameters to adjust resulting HME parameters thereby controlling quality of HME products, the high moisture extrusion (HME) system comprising:
a feeding system;
a barrel, the barrel comprising at least one screw; and
the adjustable height cooling die for shaping of a food product, the food product comprising output product conditions; and
an electronic sensor system electronically connected to the feeding system, to the barrel including to a power unit of the at least one screw, and to the adjustable height cooling die for the automatic dynamic HME feedback loop, the automatic dynamic HME feedback loop automatically and dynamically controlling the adjustable input HME parameters to adjust the resulting HME parameters and the output product conditions, thereby controlling a texture and a thickness of the food product.

2. The system of claim 1, wherein the adjustable input HME parameters include at least one of: a temperature profile of an extruder jacket, a speed of the at least one screw, a feed rate of input materials, a temperature of input materials, a feed rate of water input, a total throughput rate, a temperature of the adjustable height cooling die, a length of the adjustable height cooling die, a height of the adjustable height cooling die, and an indirect pressure control of the high moisture extrusion (HME) system.

3. The system of claim 1, wherein the resulting HME parameters include at least one of: a pressure of the high moisture extrusion (HME) system and a temperature of the high moisture extrusion (HME) system.

4. The system of claim 1, wherein the output product conditions of the food product include at least one of: a height of the food product, a temperature of the food product, and a rate of temperature change of the food product.

5. The system of claim 1, wherein the adjustable input HME parameters include an indirect pressure control of the high moisture extrusion (HME) system and a height of the adjustable height cooling die;
wherein the resulting HME parameters include a pressure of the high moisture extrusion (HME) system;
wherein the output product conditions of the food product include a rate of temperature change of the food product and a height of the food product;
wherein the electronic sensor system electronically connected to the adjustable height cooling die determines the rate of temperature change of the food product is less than a maximum threshold; and
wherein the automatic dynamic HME feedback loop automatically increases the pressure of the high moisture extrusion (HME) system by decreasing the height of the adjustable height cooling die increasing the pressure of the high moisture extrusion (HME) system and, thereby decreasing the thickness of the food product by decreasing the height of the adjustable height cooling die and controlling the texture of the food product and the thickness of the food product.

6. The system of claim 1,
wherein the adjustable input HME parameters include indirect pressure control of the high moisture extrusion (HME) system and a height of the adjustable height cooling die;
wherein the resulting HME parameters include a pressure of the high moisture extrusion (HME) system;
wherein the output product conditions of the food product include a rate of temperature change of the food product and a height of the food product;
wherein the electronic sensor system electronically connected to the adjustable height cooling die determines the rate of temperature change of the food product is greater than a maximum threshold; and
wherein the automatic dynamic HME feedback loop automatically decreases the pressure of the high moisture extrusion (HME) system by increasing the height of the adjustable height cooling die, increasing the thickness of the food product by increasing the height of the adjustable height cooling die, thereby increasing the thickness of the food product and controlling the texture and the thickness of the food product.

7. The system of claim 1,
wherein the adjustable input HME parameters include a temperature profile of an extruder jacket;
wherein the resulting HME parameters include a pressure of the high moisture extrusion (HME) system;
wherein the output product conditions of the food product include a temperature of the food product;
wherein the electronic sensor system electronically connected to the adjustable height cooling die dynamically determines the temperature of the food product; and
wherein the automatic dynamic HME feedback loop automatically and dynamically, based on the electronic sensor system dynamically determining the temperature of the food product compared to a target temperature, increases the temperature of the food product by increasing the temperature profile of the extruder jacket if the temperature of the food product is below the target temperature or decreases the temperature of the food product by decreasing the temperature profile of the extruder jacket if the temperature of the food product is above the target temperature, thereby dynamically controlling the texture of the food product and the thickness of the food product.

8. The system of claim 1,
wherein the adjustable input HME parameters include a temperature profile of an extruder jacket;
wherein the resulting HME parameters include a pressure of the high moisture extrusion (HME) system;
wherein the output product conditions of the food product include a temperature of the food product;
wherein the electronic sensor system electronically connected to the adjustable height cooling die dynamically determines the pressure of the high moisture extrusion (HME) system; and
wherein the automatic dynamic HME feedback loop automatically and dynamically, based on the electronic sensor system dynamically determining the pressure of the high moisture extrusion (HME) system compared to a target pressure, increases the pressure of the high moisture extrusion (HME) system by increasing the temperature profile of the extruder jacket if the pressure of the high moisture extrusion (HME) system is below the target pressure or decreases the pressure of the high moisture extrusion (HME) system by decreasing the temperature profile of the extruder jacket if the pressure of the high moisture extrusion (HME) system is above the target pressure, thereby dynamically controlling the texture of the food product and the thickness of the food product.

9. The system of claim 1,
wherein the adjustable input HME parameters include a speed of the at least one screw;
wherein the resulting HME parameters include a pressure of the high moisture extrusion (HME) system;
wherein the output product conditions of the food product include a temperature of the food product;
wherein the electronic sensor system electronically connected to the adjustable height cooling die dynamically determines the temperature of the food product; and
wherein the automatic dynamic HME feedback loop automatically and dynamically, based on the electronic sensor system dynamically determining the temperature of the food product compared to a target temperature, increases the temperature of the food product by increasing the speed of the at least one screw if the temperature of the food product is below the target temperature or decreases the temperature of the food product by decreasing the speed of the at least one screw if the temperature of the food product is above the target temperature, thereby dynamically controlling the texture of the food product and the thickness of the food product.

10. The system of claim 1,
wherein the adjustable input HME parameters include a speed of the at least one screw;
wherein the resulting HME parameters include a pressure of the high moisture extrusion (HME) system;
wherein the output product conditions of the food product include a temperature of the food product;
wherein the electronic sensor system electronically connected to the adjustable height cooling die dynamically determines the pressure of the high moisture extrusion (HME) system; and
wherein the automatic dynamic HME feedback loop automatically and dynamically, based on the electronic sensor system dynamically determining the pressure of the high moisture extrusion (HME) system compared to a target pressure, increases the pressure of the high moisture extrusion (HME) system by decreasing the speed of the at least one screw if the pressure of the high moisture extrusion (HME) system is below the target pressure or decreases the pressure of the high moisture extrusion (HME) system by increasing the speed of the at least one screw if the pressure of the high moisture extrusion (HME) system is above the target pressure, thereby dynamically controlling the texture of the food product and the thickness of the food product.

11. The system of claim 1,
wherein the adjustable input HME parameters include a feed rate of input materials;
wherein the resulting HME parameters include a pressure of the high moisture extrusion (HME) system;
wherein the output product conditions of the food product include a temperature of the food product;
wherein the electronic sensor system electronically connected to the adjustable height cooling die dynamically determines the temperature of the food product; and
wherein the automatic dynamic HME feedback loop automatically and dynamically, based on the electronic sensor system dynamically determining the temperature of the food product compared to a target temperature, increases the temperature of the food product by increasing the feed rate of input materials if the temperature of the food product is below the target temperature or decreases the temperature of the food product by decreasing the feed rate of input materials if the temperature of the food product is above the target temperature, thereby dynamically controlling the texture of the food product and the thickness of the food product.

12. The system of claim 1,
wherein the adjustable input HME parameters include a feed rate of input materials;
wherein the resulting HME parameters include a pressure of the high moisture extrusion (HME) system;
wherein the output product conditions of the food product include a temperature of the food product;
wherein the electronic sensor system electronically connected to the adjustable height cooling die dynamically determines the pressure of the high moisture extrusion (HME) system; and
wherein the automatic dynamic HME feedback loop automatically and dynamically, based on the electronic sensor system dynamically determining the pressure of the high moisture extrusion (HME) system compared to a target pressure, increases the pressure of the high moisture extrusion (HME) system by increasing the feed rate of the input materials if the pressure of the high moisture extrusion (HME) system is below the target pressure or decreases the pressure of the high moisture extrusion (HME) system by decreasing the feed rate of the input materials if the pressure of the high moisture extrusion (HME) system is above the target pressure, thereby dynamically controlling the texture of the food product and the thickness of the food product.

13. The system of claim 1,
wherein the adjustable input HME parameters include a feed rate of water input;
wherein the resulting HME parameters include a pressure of the high moisture extrusion (HME) system;
wherein the output product conditions of the food product include a temperature of the food product;
wherein the electronic sensor system electronically connected to the adjustable height cooling die dynamically determines the temperature of the food product; and
wherein the automatic dynamic HME feedback loop automatically and dynamically, based on the electronic sensor system dynamically determining the temperature of the food product compared to a target temperature, increases the temperature of the food product by decreasing the feed rate of water input if the temperature of the food product is below the target temperature or decreases the temperature of the food product by increasing the feed rate of water input if the temperature of the food product is above the target temperature, thereby dynamically controlling the texture of the food product and the thickness of the food product.

14. The system of claim 1,
wherein the adjustable input HME parameters include a feed rate of water input;
wherein the resulting HME parameters include a pressure of the high moisture extrusion (HME) system;
wherein the output product conditions of the food product include a temperature of the food product;
wherein the electronic sensor system electronically connected to the adjustable height cooling die dynamically determines the pressure of the high moisture extrusion (HME) system; and
wherein the automatic dynamic HME feedback loop automatically and dynamically, based on the electronic sensor system dynamically determining the pressure of the high moisture extrusion (HME) system compared to a target pressure, increases the pressure of the high moisture extrusion (HME) system by decreasing the feed rate of water input if the pressure of the high moisture extrusion (HME) system is below the target pressure or decreases the pressure of the high moisture extrusion (HME) system by increasing the feed rate of water input if the pressure of the high moisture extrusion (HME) system is above the target pressure, thereby dynamically controlling the texture of the food product and the thickness of the food product.

15. The system of claim 1,
wherein the adjustable input HME parameters include a total throughput rate;
wherein the resulting HME parameters include a temperature of the high moisture extrusion (HME) system;
wherein the electronic sensor system electronically connected to the adjustable height cooling die dynamically determines the temperature of the high moisture extrusion (HME) system; and
wherein the automatic dynamic HME feedback loop automatically and dynamically, based on the electronic sensor system dynamically determining the temperature of the high moisture extrusion (HME) system compared to a target temperature,
increases the temperature of the high moisture extrusion (HME) system by increasing the total throughput rate if the temperature of the high moisture extrusion (HME) system is below the target temperature or decreases the temperature of the high moisture extrusion (HME) system by decreasing the total throughput rate if the temperature of the high moisture extrusion (HME) system is above the target temperature, thereby dynamically controlling the texture of the food product and the thickness of the food product.

16. The system of claim 1,
wherein the adjustable input HME parameters include a temperature of the adjustable height cooling die;
wherein the resulting HME parameters include a pressure of the high moisture extrusion (HME) system;
wherein the output product conditions of the food product include a temperature of the food product;
wherein the electronic sensor system electronically connected to the adjustable height cooling die dynamically determines the temperature of the food product; and
wherein the automatic dynamic HME feedback loop automatically and dynamically, based on the electronic sensor system dynamically determining the temperature of the food product compared to a target temperature, increases the temperature of the food product by increasing the temperature of the adjustable height cooling die if the temperature of the food product is below the target temperature or decreases the temperature of the food product by decreasing the temperature of the adjustable height cooling die if the temperature of the food product is above the target temperature, thereby dynamically controlling the texture of the food product and the thickness of the food product.

17. The system of claim 1,
wherein the adjustable input HME parameters include a temperature of the adjustable height cooling die;
wherein the resulting HME parameters include a pressure of the high moisture extrusion (HME) system;
wherein the output product conditions of the food product include a temperature of the food product;
wherein the electronic sensor system electronically connected to the adjustable height cooling die dynamically determines the pressure of the high moisture extrusion (HME) system; and
wherein the automatic dynamic HME feedback loop automatically and dynamically, based on the electronic sensor system dynamically determining the pressure of the high moisture extrusion (HME) system compared to a target pressure, increases the pressure of the high moisture extrusion (HME) system by decreasing the temperature of the adjustable height cooling die if the pressure of the high moisture extrusion (HME) system is below the target pressure or decreases the pressure of the high moisture extrusion (HME) system by increasing the temperature of the adjustable height cooling die if the pressure of the high moisture extrusion (HME) system is above the target pressure, thereby dynamically controlling the texture of the food product and the thickness of the food product.

18. The system of claim 1,
wherein the adjustable input HME parameters include a length of the adjustable height cooling die;
wherein the resulting HME parameters include a pressure of the high moisture extrusion (HME) system;
wherein the output product conditions of the food product include a temperature of the food product;
wherein the electronic sensor system electronically connected to the adjustable height cooling die dynamically determines the temperature of the food product; and
wherein the automatic dynamic HME feedback loop automatically and dynamically, based on the electronic sensor system dynamically determining the temperature of the food product compared to a target temperature, increases the temperature of the food product by increasing the length of the adjustable height cooling die if the temperature of the food product is below the target temperature or decreases the temperature of the food product by decreasing the length of the adjustable height cooling die if the temperature of the food product is above the target temperature, thereby dynamically controlling the texture of the food product and the thickness of the food product.

19. The system of claim 1,
wherein the adjustable input HME parameters include a length of the adjustable height cooling die;
wherein the resulting HME parameters include a pressure of the high moisture extrusion (HME) system;
wherein the output product conditions of the food product include a temperature of the food product;
wherein the electronic sensor system electronically connected to the adjustable height cooling die dynamically determines the pressure of the high moisture extrusion (HME) system; and
wherein the automatic dynamic HME feedback loop automatically and dynamically, based on the electronic sensor system dynamically determining the pressure of the high moisture extrusion (HME) system compared to a target pressure, increases the pressure of the high moisture extrusion (HME) system by increasing the length of the adjustable height cooling die if the pressure of the high moisture extrusion (HME) system is below the target pressure or decreases the pressure of the high moisture extrusion (HME) system by decreasing the length of the adjustable height cooling die if the pressure of the high moisture extrusion (HME) system is above the target pressure, thereby dynamically controlling the texture of the food product and the thickness of the food product.

20. The system of claim 1, wherein the adjustable height cooling die comprises a round gap in the adjustable height cooling die, the round gap being adjustable in a horizontal direction for shaping of the food product.

21. The system of claim 1, wherein the adjustable height cooling die comprises a flat shape that is adjustable in a vertical direction for shaping of the food product.

22. The system of claim 1, wherein the adjustable height cooling die comprises a moveable lid for changing a height of the adjustable height cooling die for shaping of the food product.

23. A system for high moisture extrusion (HME) food processing using an adjustable height cooling die including an automatic dynamic HME feedback loop, the system comprising:
a high moisture extrusion (HME) system including adjustable input HME parameters including an indirect pressure control of the high moisture extrusion (HME) system and a height of the adjustable height cooling die to adjust resulting HME parameters controlling quality of HME products including a pressure of the high moisture extrusion (HME) system, the high moisture extrusion (HME) system comprising:
a feeding system;
a barrel, the barrel comprising at least one screw; and
the adjustable height cooling die for shaping of a food product, the food product comprising output product conditions including a rate of temperature change of the food product and a height of the food product; and
an electronic sensor system electronically connected to the feeding system, to the barrel including to a power unit of the at least one screw, and to the adjustable height cooling die for the automatic dynamic HME feedback loop, the automatic dynamic HME feedback loop automatically and dynamically controlling the adjustable input HME parameters to adjust the resulting HME parameters and the output product conditions, thereby controlling a texture and a thickness of the food product;
wherein the electronic sensor system electronically connected to the adjustable height cooling die determines the rate of temperature change of the food product is less than a maximum threshold; and
wherein the automatic dynamic HME feedback loop automatically increases the pressure of the high moisture extrusion (HME) system by decreasing the height of the adjustable height cooling die increasing the pressure of the high moisture extrusion (HME) system and, thereby decreasing the thickness of the food product by decreasing the height of the adjustable height cooling die and controlling the texture of the food product and the thickness of the food product.

24. A system for high moisture extrusion (HME) food processing using an adjustable height cooling die including an automatic dynamic HME feedback loop, the system comprising:
a high moisture extrusion (HME) system including adjustable input HME parameters including indirect pressure control of the high moisture extrusion (HME) system and a height of the adjustable height cooling die to adjust resulting HME parameters controlling quality of HME products including a pressure of the high moisture extrusion (HME) system, the high moisture extrusion (HME) system comprising:
a feeding system;
a barrel, the barrel comprising at least one screw; and
the adjustable height cooling die for shaping of a food product, the food product comprising output product conditions including a rate of temperature change of the food product and a height of the food product; and
an electronic sensor system electronically connected to the feeding system, to the barrel including to a power unit of the at least one screw, and to the adjustable height cooling die for the automatic dynamic HME feedback loop, the automatic dynamic HME feedback loop automatically and dynamically controlling the adjustable input HME parameters to adjust the resulting HME parameters and the output product conditions, thereby controlling a texture and a thickness of the food product;
wherein the electronic sensor system electronically connected to the adjustable height cooling die determines the rate of temperature change of the food product is greater than a maximum threshold; and
wherein the automatic dynamic HME feedback loop automatically decreases the pressure of the high moisture extrusion (HME) system by increasing the height of the adjustable height cooling die, increasing the thickness of the food product by increasing the height of the adjustable height cooling die, thereby increasing the thickness of the food product and controlling the texture and the thickness of the food product.
